(19) United States
(12) Patent Application Publication
(10) Pub. No.: US 2004/0030612 A1
(43) Pub. Date: Feb. 12, 2004

(54) Method for operating an electronic shopping system

(76) Inventors: Frank Dusella, Laufenburg (DE); Rainer Thalweiser, Buggingen (DE)

Correspondence Address: JONES, TULLAR & COOPER, P.C., P.O. Box 2266 Eads Station, Arlington, VA, 22202, US

(21) Appl. No.: 10/440,425

(22) Filed: May 19, 2003

Related U.S. Application Data
(60) Provisional application No. 60/388,351, filed on Jun. 14, 2002.

(30) Foreign Application Priority Data
May 17, 2002 (DE) 10 222 603.2

(51) Int. Cl. G06F 17/60

(52) U.S. Cl. 705/26

(57) ABSTRACT

In a method for operating an electronic shopping system, a business-to-business and business-to-customer system are integrated together.

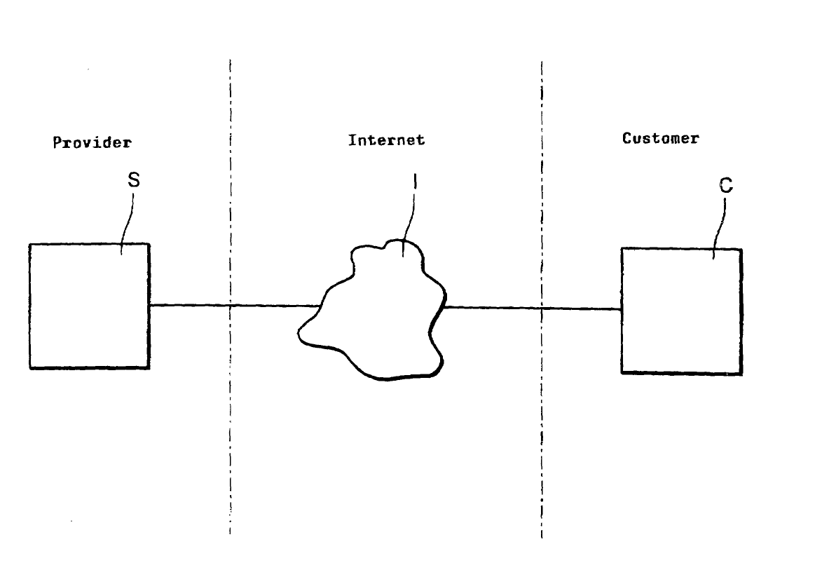

The invention relates to a method for operating an electronic shopping system.

Electronic shopping is gaining more and more importance in modern business transactions between customers and providers. Errors in order processes are considerably reduced through the paperless exchange of information. A further advantage of electronic shopping is the high availability 24 h a day,

In electronic shopping, the customer dials up the homepage of the provider in the electronic shop. The electronic shop essentially comprises an electronic catalog with the products offered by the provider. In this case, the customer selects specific product properties by clicking on the mouse and can order the desired product at the end of the selection (e.g. under www.e-direct.de of Endress+Hauser).

In principle, there are two forms of shopping systems: business-to-business and business-to-customer systems. Business-to-business systems are principally used in business transactions between companies, and business-to-customer systems are principally used in business transactions between companies and end customers.

In business-to-business shop solutions, registration and authentication (e.g. via user/password) is necessary immediately upon dial-up, in order to display the display of customer-specific information (prices, order formalities etc.) on the customer's computer system. In business-to-customer shop solutions, registration upon dial-up is not generally necessary. The customer enters the online shop “anonymously” and can thus see only generally accessible information. Therefore, a customer-specific display of prices is not possible.

In the known shopping systems, the business-to-business and business-to-customer systems are always used separately.

If a provider wishes to make both systems available to the customers, then said provider has to install said systems separately in each case.

This is extremely costly on the part of the provider, since two separate systems have to be installed, serviced and maintained. In the event of changes to product properties, these always have to be reworked in both systems, as also in the case of the integration of new products into the electronic catalog.

The process for ordering a product is likewise very involved on the part of the customer, since the latter must always register itself in the case of a business-to-business shopping system, even if it wishes only to “browse” through the electronic catalog.

A further disadvantage of known electronic shopping systems is that the customer can only select products from the electronic product catalog. However, it is often the case that not all of the products of the provider are listed in the product catalog, Such products cannot be selected by the customer.

A further disadvantage of electronic shopping systems is that, in the individual selection steps, product properties are displayed to the customer which, although they can be selected by said customer, are only subjected at the end of the selection to a check to determine whether the selected product properties are permissible.

It is an object of the invention to specify a method for operating the electronic shopping system which does not have the disadvantages specified above and which is, in particular, convenient for customers and cost-effective.

This object is achieved by means of the features specified in the respective main claims.

An essential idea of the invention is that, for each menu step of the selection process, registration of the customer with the provider is made possible in order thereby to display customer-specific information.

A further essential idea of the invention is that the customer can also choose products that are not listed in the electronic catalog.

A further essential idea of the invention is that, for each selection step, only permissible combinations of product properties are displayed.

Advantageous further developments of the invention are specified in the respective subclaims.

The method according to the invention is explained in more detail below with reference to a FIGURE.

The single FIGURE illustrated shows a computer unit C at the customer end, which serves as client. The computer unit C is connected via the Internet I to a computer unit S at the provider end, which serves as server.

The customer dials up the computer unit S of the provider via the computer unit C. Via a plurality of menu steps, said customer selects a product from an electronic catalog (usually with various main pages). During the selection, said customer determines specific product properties, such as electronic connections, mechanical connections, embodiments (e.g. Ex variants). Without prior registration of the customer, only generally accessible information (e.g. catalog prices) are displayed to the customer on the latter's computer unit C. If the customer wishes to be displayed customer-specific information, such as customer-specific prices or its customer-specific order functionality, then registration can be effected for each menu step. After registration, which is generally effected via a user name and a password, the customer-specific information is displayed to the customer. The essential invention is that the customer does not have to decide as early as during the dial-up to the electronic shopping system whether said customer wishes to have generally accessible information or customer-specific information made available.

Since customer-specific prices are extremely sensitive information it is provided that the customer-specific information is not made available to every user on the part of the customer.

If the customer wishes to order a product of the provider which is not listed in the electronic catalog, but it knows the order number of said product, then it can have displayed to it, by inputting the order number, the list price or, alternatively, after registration anew, its customer-specific price. The same functionalities are made available for these products that are not listed in the electronic catalog and for products which are carried in the electronic catalog (e.g. price display, customer-specific price, delivery times, product configuration).

The essential advantage of this method is that the customer has access to all the products of the provider.

For each selection step, only permissible combinations of product properties are displayed; i.e., after each selection step, an immediate exclusion check is effected and, in the subsequent selection step, only those combinations of product properties which can actually be supplied are displayed.

In an advantageous manner, not all of the permissible combinations are simultaneously displayed to the customer, but rather only 20% of the most common combinations. That facilitates selection at the customer end. Only if said customer cannot find its product variant on the page displayed can it have further product variants displayed by clicking.

The computer unit S is connected e.g. to a SAP® R/3 system.

1. A method for operating an electronic shopping system, in which a customer electronically dials a provider and selects a product of the provider via a plurality of menu steps from an electronic catalog of the provider,
wherein, for each menu step, registration of the customer with the provider is possible and, as a result, customer-specific information is displayed.

2. The method as claimed in claim 1, wherein the process of dialing the provider is effected via the Internet.

3. The method as claimed in one of the preceding claims, wherein the customer-specific information is customer-specific prices.

4. The method as claimed in one of the preceding claims, wherein the customer-specific information is a customer-specific order functionality.

5. The method as claimed in one of the preceding claims, wherein, on the part of the customer, the access to customer-specific information is possible only for specific users.

6. A method for operating an electronic shopping system, in which a customer electronically dials a provider and selects a product of the provider via a plurality of menu steps from an electronic catalog, wherein selection of a product that is not listed in the electronic catalog is also possible.

7. The method as claimed in claim 6, wherein the selection of the product that is not listed in the electronic catalog is effected by way of its order number.

8. A method for operating an electronic shopping system, in which a customer electronically dials a provider and selects a product of the provider via a plurality of menu steps from an electronic catalog, wherein for each selection step, only permissible combinations of product properties are displayed.

9. The method as claimed in claim 8, wherein to start with only 20% of the most common product properties are displayed to the customer.

10. The method as claimed in one of the preceding claims, wherein, at the provider end, the selection is effected via a SAP system.
